(19) United States
(12) Patent Application Publication
(10) Pub. No.: US 2025/0086701 A1
(43) Pub. Date: Mar. 13, 2025

(54) EXPENSE MANAGEMENT SYSTEM FOR IMPROVED DATA CAPTURE

(71) Applicant: MASTERCARD INTERNATIONAL INCORPORATED, Purchase, NY (US)

(72) Inventor: Olivia McCormick, Harrison, NY (US)

(21) Appl. No.: 18/367,718

(22) Filed: Sep. 13, 2023

(51) Int. Cl. G06Q 40/02; G06Q 20/34; G06Q 20/38; G06Q 20/40

(52) U.S. Cl. CPC G06Q 40/02; G06Q 20/34; G06Q 20/389; G06Q 20/40

(57) ABSTRACT

An expense management platform with transaction data service creates transaction display packages to replace certain transaction information, for example, by receiving transaction information of a transaction made with a payment card, the transaction information including a merchant identification; obtaining, from a merchant data mapping resource, merchant content corresponding to the merchant identification, the merchant content comprising a brand name; and generating a transaction display package comprising the brand name. The transaction display package can be sent over a communication channel to prompt receipt intake. The transaction display package can be provided to a particular endpoint where content to display includes the transaction information.

### BACKGROUND

Expense management is a multi-step process that includes tracking, reporting, submitting, approving, and reimbursing employee business expenses. Many companies use expense management software to simplify the process of expense reimbursement and reconciliation process. Expense management software replaces manual paperwork with an automated workflow to upload, track, and submit expense receipts conveniently. These reimbursement receipts are accessible to administrators through a streamlined process to approve the claims while checking for any corporate policy violations. In this manner, organizations can keep track of employees' corporate expenses.

However, navigating through the sea of similar-looking transaction records in an expense management system (which often have inadequate or confusing descriptions, can make working with expense management software frustrating and time-consuming. Often, companies manage a large volume of business expense transactions, spanning many different sectors of the company. Matching transactions to purchases by particular employees can be inefficient. Therefore, there is a need to improve efficiency in the approval process of transactions using expense management software.

### BRIEF SUMMARY

An expense management system is described. Through certain implementations of the described systems and techniques it can be possible to improve data capture and reduce human error in matching of purchases and approval processes.

An expense management platform with transaction data service creates transaction display packages to replace certain transaction information, for example, by receiving transaction information of a transaction made with a payment card, the transaction information including a merchant identification; obtaining, from a merchant data mapping resource, merchant content corresponding to the merchant identification, the merchant content comprising a brand name; and generating a transaction display package comprising the brand name. The transaction display package can be sent over a communication channel to prompt receipt intake. The transaction display package can be provided to a particular endpoint where content to display includes the transaction information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment of an expense management platform.

FIG. 2 illustrates an example operating environment of an expense management platform incorporating a transaction data service.

FIG. 3 illustrates a method performed by a transaction data service.

FIGS. 4A and 4B are process flow diagrams illustrating example payment tracking and approving process flows.

FIG. 5A illustrates an example receipt tracking view in a graphical user interface of an expense management system.

FIG. 5B illustrates another example receipt tracking view in a graphical user interface of an expense management system.

FIG. 5C illustrates an example notification message.

FIG. 6 illustrates components of a computing system.

### DETAILED DESCRIPTION

An expense management system is described. Through certain implementations of the described systems and techniques it can be possible to improve data capture and reduce human error in matching of purchases and approval processes.

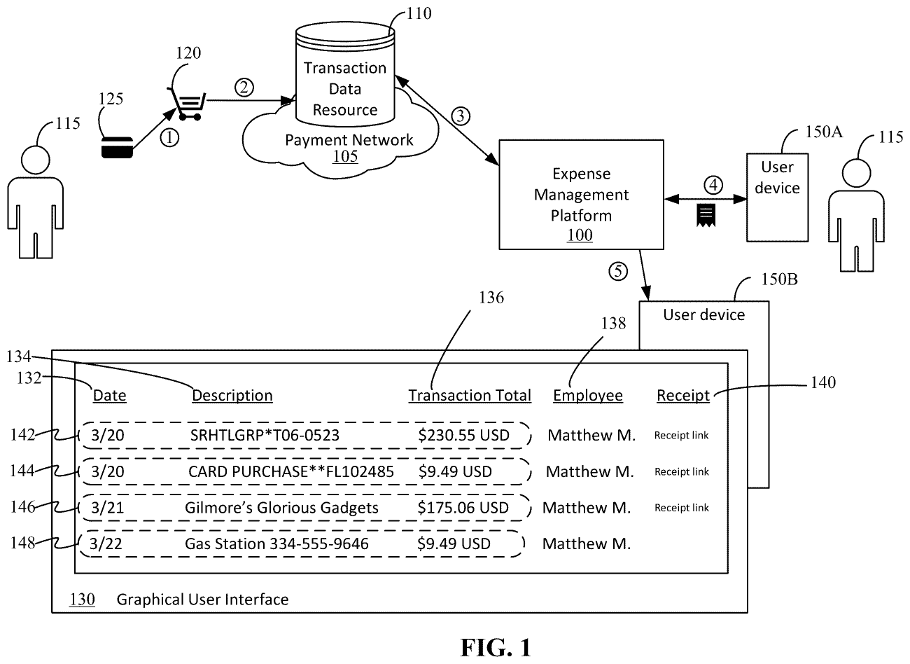

FIG. 1 illustrates an example operating environment of an expense management platform. Referring to FIG. 1, an expense management platform 100 provides a hub for collecting, tracking, and approving (and even reimbursing) corporate expense transactions, offering services such as facilitating expense report creation, submissions, approvals, reimbursements, and general business expense accounting through integrations with a payment network 105 and various user interfaces for capturing and displaying information, including a receipt tracking graphical user interface 130.

For example, expense management platform 100 can interface with a transaction data resource 110 to receive information from the transaction data resource 110 for a plurality of payment cards (e.g., company credit card 125) registered at the expense management platform 100. The transaction data resource 110 can be part of a service provided by a card issuer or payment processor network. The information from the transaction data resource 110 can be viewed through user interfaces provided by the expense management platform 100, for example, in a receipt tracking graphical user interface 130 as well as other graphical user interfaces (provided by the expense management platform 100 or other applications receiving content from the expense management platform 100). In addition, the information from the transaction data resource 110 can be used by the expense management platform for various functionality, including triggering of notifications requesting receipts and even automated expense to receipt matching.

As an illustrative scenario of operation of expense management platform 100, employee 115, working for Company A, may complete (1) a transaction at merchant 120 using a company credit card 125. The transaction is captured on the payment network 105, for example, at transaction data resource 110. Since the company credit card 125 is registered at the expense management platform 100 for convenient tracking of Company A related transactions made using the company credit card 125, the expense management platform 100 can easily obtain (3) the transaction information corresponding to the completed transaction.

In some cases, the expense management platform 100 uses received transaction information to trigger a notification message to employee 115. The notification message can be a notice of the charge include a request to submit the corresponding receipt from the employee's user device 150A, which may be any suitable computing system not limited to a tablet, mobile device, smartwatch, or laptop. Separately from receipt of the transaction information from the transaction data resource 110 or in response to the notification message, the expense management platform 100 can receive (4) a receipt (e.g., in the form of a link, a photo, a PDF, etc.) from the employee 115. The received receipt and the completed transaction are matched either manually or automatically at the expense management platform 100.

As part of a receipt tracking view of a graphical user interface 130, the expense management platform 100 can provide for display (5), at a user device 150B, transactions corresponding to the company credit cards of employees, including company credit card 125 of employee 115. In the illustrative scenario, the receipt tracking view includes a date 132, a description 134, a transaction total 136, an employee name 138, and a receipt link 140 for each listed transaction (e.g., transaction 142, transaction 144, transaction 146, transaction 148). User device 150B may be any suitable computing system not limited to a tablet, mobile device, smartwatch, laptop, or desktop.

Some of the challenges with approving a particular transaction and identifying a matching receipt is that merchant information that forms part of a transaction detail may not always be readily identifiable as being from the place of business that the purchase occurred. In addition, the information presented on receipts is not in any standard format across different merchants.

As one illustrative scenario, the receipt tracking view of a graphical user interface 130 may be viewed by someone acting as an expense approver. When approving business expense transactions, it is beneficial for the approver to easily determine necessary details regarding the transaction, such as the merchant's name. This allows the approver to make an informed decision when approving/denying the transaction.

Consider transaction 142, having the description 134 “SRHTLGRP*T-060523.” In some cases, when displaying the descriptions 134 for a given transaction, the expense management platform 100 is limited by the transaction information received from the transaction data resource 110. However, the quality of the transaction data presented for display at the expense management platform 100 can have an impact on the ability of a viewer of the graphical user interface to understand what is being displayed.

For example, if an approver is attempting to make the determination of whether or not to approve transaction 142, given that the provided description 134 is “SRHTLGRP*T-060523,” the approver may need to take further steps either through additional interactions with the expense management platform 100 or with applications and computing resources outside of the expense management platform 100. Because the graphical user interface 130 displays just the information received from the transaction data resource 110 for the description 134 for transaction 142, the approver may find it necessary to perform additional actions to find merchant identification details, such as, but not limited to, following the receipt link 140 for transaction 142, opening a web browser to search for the description information, or searching for other transactions having the same description. In some cases, there may not be a receipt available (e.g., transaction 148 is missing a receipt link 140), which may further increase the time investment required to approve transaction 142.

In another illustrative scenario, suppose that the same transaction information as shown in the graphical user interface 130 is used to prompt the employee 115 to submit a corresponding receipt. Due to the transaction detail provided by the transaction data resource 110, it may be difficult for the employee 115 to determine which receipt corresponds to transaction 148. The description 134 for transaction 148 is “Gas Station 334-555-9646.” After a long business trip, for example, it may not be immediately apparent to the employee 115 which gas station/gas station transaction corresponds to transaction 148 since the date of charge may not match a specific date on a receipt and the name of the gas station may be one that employee 115 used multiple days. This determination may also be difficult when transactions share similarities, for example where transaction 144 and transaction 148 have the same transaction total 136 of “$9.49 USD.” Some solutions attempt to address part of this problem by triggering a request for a receipt based on a pre-auth request from a merchant (or response from issuer) as identified by the payment network 105. However, there can still be challenges with reducing errors.

Accordingly, a transaction data service is included for an expense management platform to improve data capture and reduce human error in matching of purchases and approval processes.

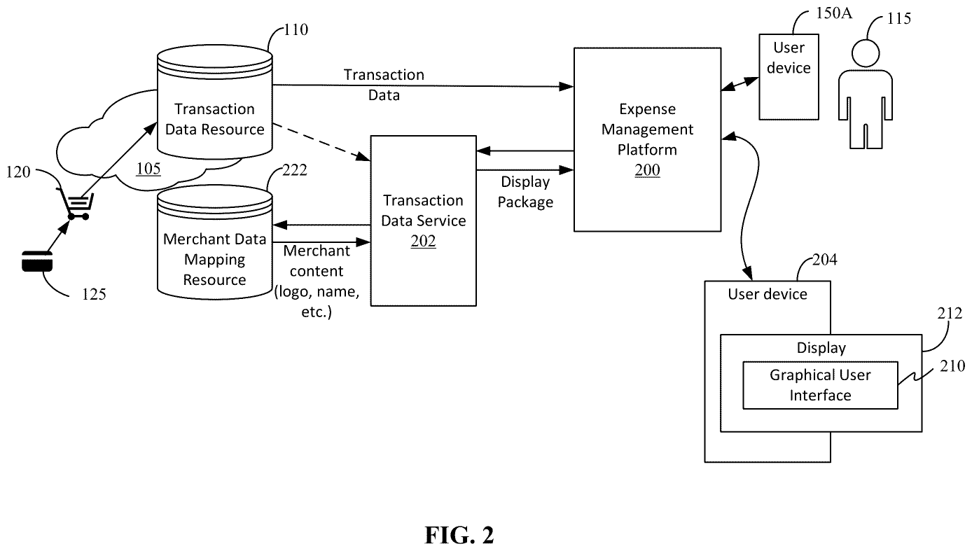

FIG. 2 illustrates an example operating environment of an expense management platform incorporating a transaction data service. Referring to FIG. 2, an expense management platform 200 utilizing a transaction data service 202 can improve receipt intake and approval processes.

Similar to that described with respect to FIG. 1, a user can interact with expense management platform 200 through various user interfaces (e.g., graphical user interface 210 displayed at display 212 of user device 204) for capturing and displaying information. In addition, similar to that described with respect to expense management platform 100 of FIG. 1, expense management platform 200 can interface with a transaction data resource 110 associated with a payment network 105 to receive information from the transaction data resource 110 for a plurality of payment cards (e.g., transactions at merchants such as merchant 120 using company credit card 125) registered at the expense management platform 200. In some cases, expense management platform 200 may, in addition to or instead of directly interfacing with the transaction data resource 110, interface with the transaction data resource 110 through transaction data service 202.

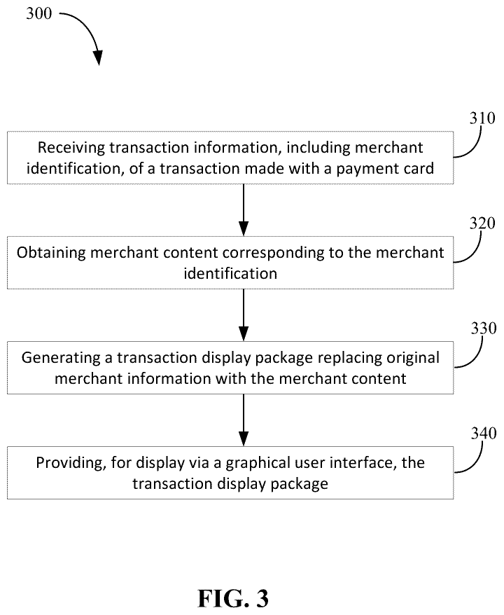

Transaction data service 202 generates display packages for transaction information for the graphical user interfaces of the expense management platform 200, for example as described with respect to method 300 of FIG. 3. Transaction data service 202 communicates with a merchant data mapping resource 222 for merchant content including images and other information to obtain the content used to create the display packages. In some cases, some or all of the functionality of transaction data service 202 is part of the expense management platform 200. In some cases, the transaction data service 202 is a service provided by the payment network. In some cases, the transaction data service 202, the transaction data resource 220, and the merchant data mapping resource 222 are part of the expense management platform 200.

Advantageously, the creation of a transaction display package not only enables a viewer of a graphical user interface to more quickly understand the information presented both for receipt intake and for expense approvals, but the transaction data service can further support receipt matching.

In addition to the enhancements to the graphical user interfaces, the expense management platform can provide further support for expense review and approval through application of personas.

A “persona” is an employee profile type. The persona can provide a better picture of what expenses should be expected for each an employee of each persona, making approving expenses at the expense management platform more efficient and accurate. Example personas include “sales”, “people manager”, “executive”, “administrative assistant”, “marketing”, “accounting”, and “IT.”

A persona may be manually assigned to an employee or automatically assigned based on existing employee role. A persona can include a profile of transaction types (e.g., hotel purchases, technology purchases, dinner purchases, etc.) expected and/or unexpected based on the job expectations attributed to that particular persona. In some cases, the expense management platform 200 can cause transaction information in a display interface to be flagged or highlighted based on the particular transaction deviating from the transactions expected for an assigned persona. The flagging or highlighting can be reflected in the GUI 210 as a flag, alert, pop-up message, etc. The GUI 210 can include functionality that allows for a user to remove the flag and approve the expense. Since the transaction display package replaces the merchant information from a transaction with particular merchant content, an approver can more quickly identify what action should be taken with the transaction.

FIG. 3 illustrates a method performed by a transaction data service. Referring to FIG. 3, method 300 includes receiving (310) transaction information of a transaction made with a payment card, the transaction information including a merchant identification; obtaining (320), from a merchant data mapping resource, merchant content corresponding to the merchant identification; generating (330), at the transaction data service, a transaction display package replacing original merchant information with the merchant content; and providing (350), for display via a graphical user interface, the transaction display package.

In some cases, the transaction information including the merchant identification is received (310) at the transaction data service in response to the expense management platform receiving a call to provide content to display to a particular endpoint where the content to display includes the transaction information. In some of such cases, the expense management platform can send a request for a display package to the transaction data service and that request can include at least the merchant identification. In some cases, the request for a display package includes all of the transaction information that would be part of the content to display to the particular endpoint. In some cases, the transaction data service customizes the content for display based on the type of endpoint, for example, by selecting which merchant content (and/or size of content) of the merchant identified by the merchant identification to obtain (320) from the merchant data mapping resource. In some cases, the transaction data service manages the merchant data mapping resource.

In some cases, the transaction data service can obtain (320) the merchant content by identifying the merchant identification from the received transaction information and using the identified merchant identification to search the merchant data mapping resource for a set of associated merchant content. The merchant content can include a merchant logo and brand name. A brand name is the particular name of the merchant that is the name usually marketed for that merchant. In some cases, the merchant content includes a merchant location (e.g., merchant address). The merchant content and other transaction information can be used to generate (330) the transaction display package. In some cases, the transaction data service calls a map service to obtain a map image for the merchant location to include in the transaction display package.

In some cases, the transaction data service provides (340) the transaction display package for display through the expense management platform.

Method 300 may be performed any time transaction content is to be displayed in a graphical user interface.

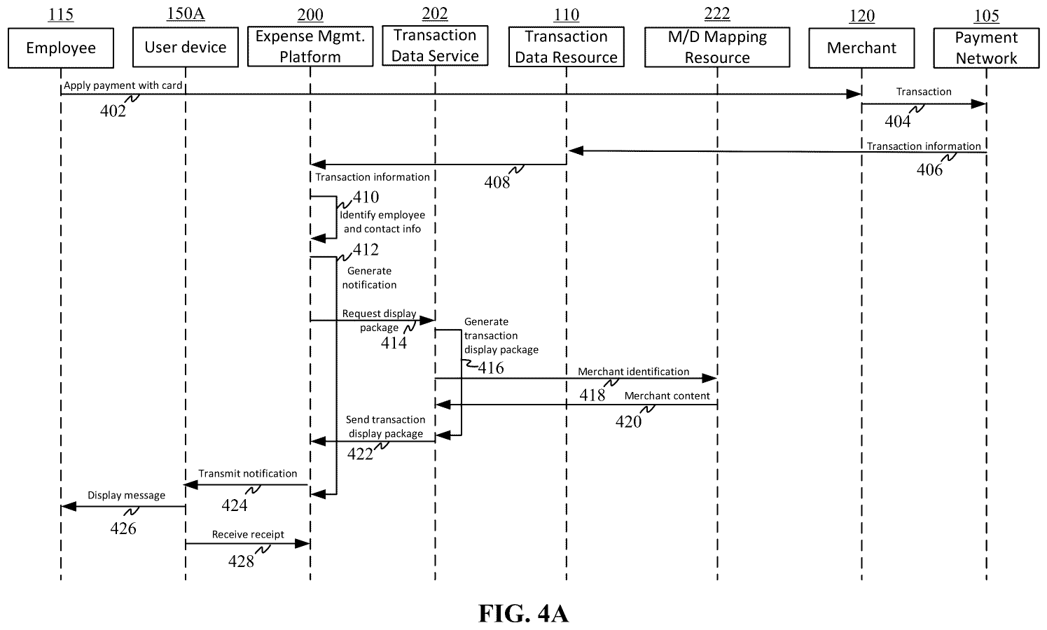

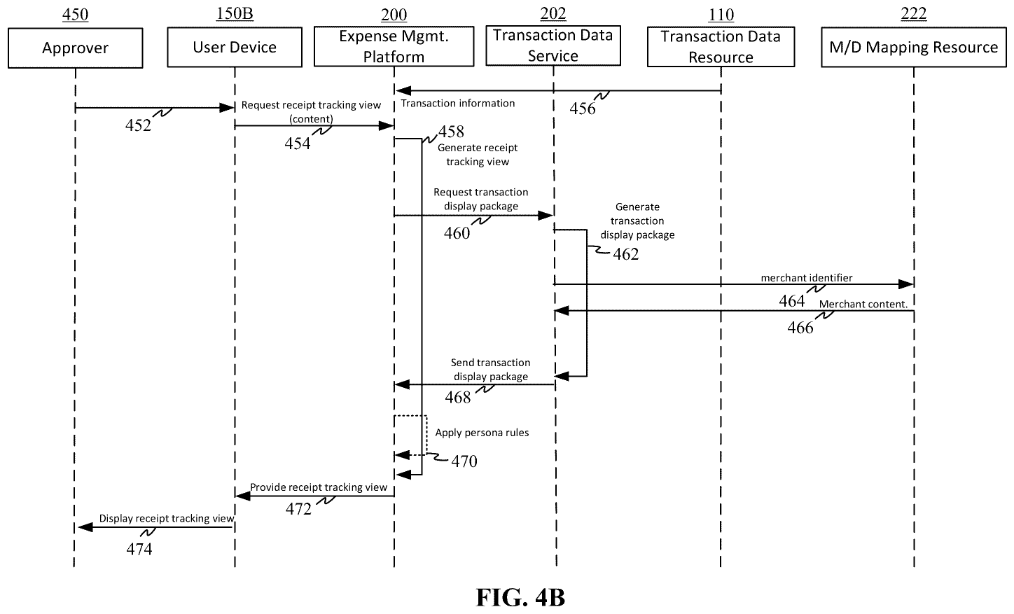

FIGS. 4A and 4B are process flow diagrams illustrating example payment tracking and approving process flows.

In an example scenario for collecting receipts, referring to FIGS. 2 and 4A, employee 115 conducts transactions using a company credit card 125, for example, at merchant 120 (e.g., applying (402) payment in person or online using card). Transaction (404) at merchant 120 is processed using the payment network 105 and certain details are stored by the transaction data resource 220 Certain transaction information (406) from the transaction is collected at the transaction data resource 110. The transaction information can be received (408) at the expense management platform 200 and this information may trigger the expense management platform to generate and send a notification to the employee 115 for a receipt corresponding to the transaction. In some cases, the transaction information is received at the expense management platform during a pre-authorization process for the transaction at the merchant (e.g., instead of or in addition to a message from issuer to cardholder confirming/informing of the transaction).

In the illustrative scenario, the expense management platform identifies (410) a corresponding employee and their contact information, generate (412) a notification message, and transmit (424) the notification message to the employee through the contact information. The employee can be identified from the transaction information (e.g., through records associating payment cards with specific employees or by the transaction information itself) and the contact information (e.g., phone number, email, device identifier) can be identified from employee records accessible by the expense management platform 200. Using the identified contact information, the notification message may be sent through a communication channel such as a messaging or email application or may be through a corresponding expense management application on the user device 150A.

The expense management platform 200 can, when generating (412) the notification message, request (414) the transaction data service 202 to generate a transaction display package. The request can include certain of the transaction information. In response to the request (414) for a transaction display package, the transaction data service 202 can generate (416) a transaction display package.

To generate (416) the transaction display package, the transaction data service 202 can identify the merchant identification included in the transaction information received from the expense management platform 200; and can use (418) the merchant identification to obtain (420) merchant content from the merchant data mapping resource 222. The merchant content can include a merchant logo and brand name (which may be an image file). In some cases, the merchant content includes a merchant location (e.g., merchant address). The merchant content and other transaction information can be used to generate the transaction display package, which is sent (422) to the expense management platform 200 for replacing or supplementing the content used by the expense management platform 200 when generating (412) the notification message.

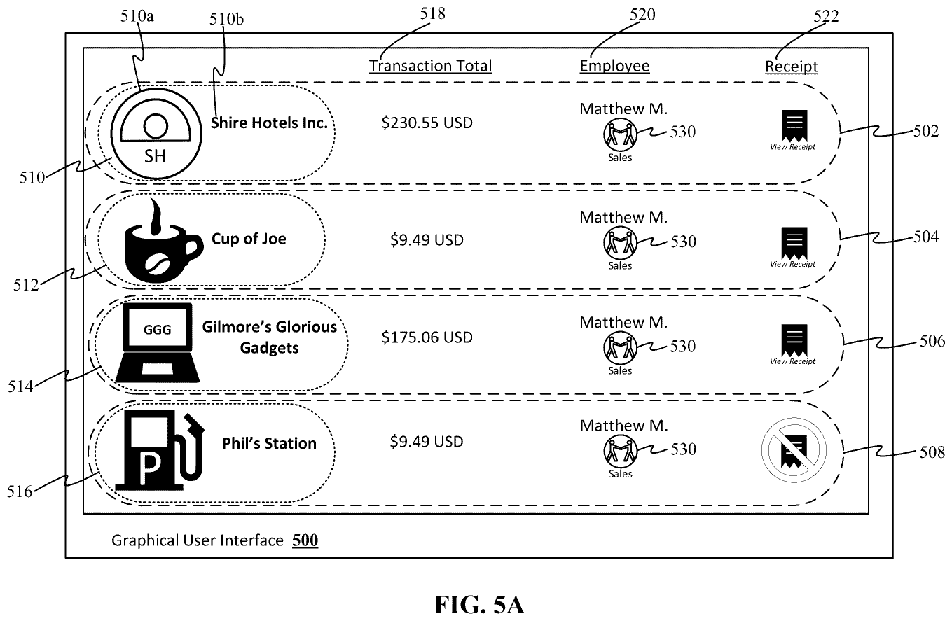

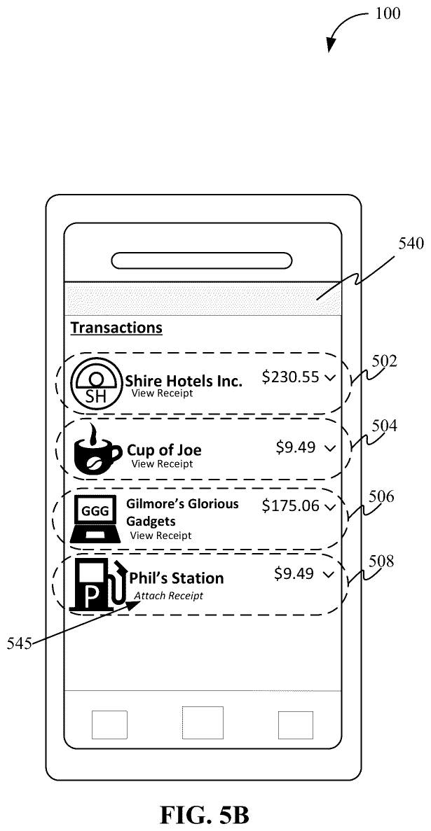

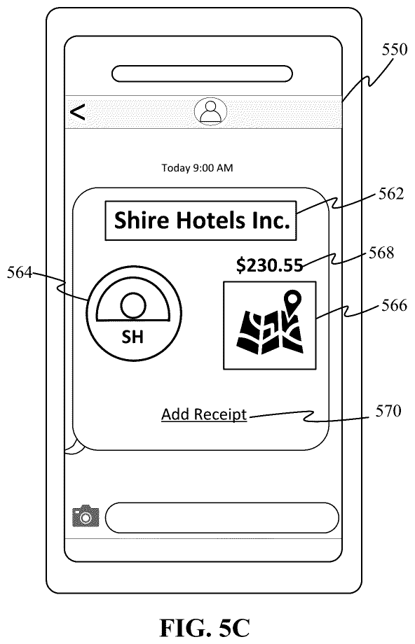

After the notification is transmitted (424) by the expense management platform 200 to the user device 150A, the user device 150A can display (426) the notification message to prompt the employee to submit the receipt, which can be received by the expense management platform 200 and associated with the correct transaction. As described in more detail with respect to FIGS. 5B and 5C, the transaction display package enables a more readable interface.

In an example scenario for expense tracking and approval, referring to FIGS. 2 and 4B, an approver user 450 may be accessing (452) the expense management platform 200 from their user device 150B, for example to view a receipt tracking view. An application (e.g., web browser or expanse management platform application) running on the user device 150B requests the receipt tracking view content from the expense management platform 200. Since the expense management platform 200 receives (456) transaction information from transaction data resource 110, the expense management platform 200 can use the transaction information to generate (458) a receipt tracking view. As part of generating (458) a receipt tracking view, the expense management platform 200 requests (460) the transaction data service 202 to generate a transaction display package. The request can include certain of the transaction information. In response to the request (460) for a transaction display package, the transaction data service 202 can generate (462) a transaction display package.

To generate (462) the transaction display package, the transaction data service 202 can obtain merchant information corresponding to the merchant identification included in the transaction information received from the expense management platform 200; and can use (464) the merchant identification to obtain (466) merchant content from the merchant data mapping resource 222. The merchant content can include a merchant logo and brand name (which may be an image file). In some cases, the merchant content includes a merchant location (e.g., merchant address). The merchant content and other transaction information can be used to generate the transaction display package, which is sent (468) to the expense management platform 200 for replacing or supplementing the content used by the expense management platform 200 when generating (458) the receipt tracking view. Once the receipt tracking view is generated (458), the expense management platform 200 can provide (472) the receipt tracking view to the user device 150B to surface/display (474) in the graphical user interface.

Optionally, in some cases, the expense management platform 200 can, when generating the receipt tracking view, apply (470) persona rules for employees associated with transactions used in the receipt tracking view.

As part of applying (470) persona rules, the expense management platform 200 can, for example, identify an employee associated with a set of transactions (e.g., associated with a payment card having conducted the set of transactions); and retrieve persona rules corresponding to the particular persona assigned to that employee. Using the persona rules, the expense management platform 200 can determine transactions that do not satisfy the persona rules and apply indicators to the transaction strings to cause flags or highlighting to surface in a graphical user interface. The applying of indicators can include inserting appropriate tags or metadata into the content file provided for display as well understood in the art (e.g., document object model (DOM) file, cascading style sheets (CSS) file, etc.). As mentioned above, providing information associated with an assigned persona of an employee in connection with a transaction can provide additional contextual information for a user.

FIGS. 5A-5C illustrate example representations of transaction display packages in graphical user interfaces as described herein.

FIG. 5A illustrates an example receipt tracking view in a graphical user interface of an expense management system. Referring to FIG. 5A, a graphical user interface (GUI) 500 can display a receipt tracking view providing transaction information for a plurality of transactions. In the example view, the transactions are displayed for a single employee. Various filtering and sorting functionalities can be included to support such a view.

As can be seen, each of the plurality of transactions (e.g., transaction 502, transaction 504, transaction 506, and transaction 508) includes the merchant content of a transaction display package (e.g., merchant content 510, merchant content 512, merchant content 514, and merchant content 516), a transaction total 518, an employee 520, and a link to a receipt 522.

Advantageously, including a transaction display package for each transaction streamlines a user's experience and provides purchase transparency while using an expense management system (e.g., expense management platform 200 of FIG. 2). The transaction display package provides higher-quality visualization of merchant details that increases user efficiency while using the expense management system. By displaying a merchant logo (e.g., merchant logo 510a) and/or a merchant name (e.g., merchant name 510b) for each transaction item (e.g., transaction 502), a user can quickly identify important details of a transaction. Displaying transaction display packages with each transaction can eliminate confusion, time, and costs associated with transaction/expense management.

For example, a user may quickly identify transaction 502 as a hotel purchase by the merchant name 510b or by recognizing the merchant logo 510a. If the original merchant identification in the transaction was not clearly a brand name, additional steps may need to be taken to identify the merchant, including accessing additional applications (e.g., web browser and search engine) to determine what the expense was for. Therefore, providing the transaction display package for each transaction can make approving transactions quicker and easier, as a user can nearly instantly make determinations and distinctions regarding transactions while staying within the expense management platform viewer/user interface.

For example, compare transaction 502, as displayed in expense management system GUI 500 of FIG. 5A, to transaction 142, as displayed in expense management platform GUI 130 of FIG. 1. Both transaction 502 of FIG. 5A and transaction 142 of FIG. 1 represent the same transaction information for a hotel purchase made by employee Matthew M. on 3/20 at Shire Hotel Inc. for $230.55 USD. However, expense management system GUI 500 displays the transaction information more clearly than the expense management platform GUI 130, by providing transaction display package (e.g., merchant content 510) in association with transaction 502. Therefore, a user viewing expense management system GUI 500 would more easily and more quickly identify the relevant information regarding the transaction (as opposed to a user viewing expense management platform GUI 130 of FIG. 1, which does not include a transaction display package).

In some cases, the expense management system GUI 500 can indicate a persona 530 for each employee 520 attributed to a transaction. For example, in FIG. 5A the persona 530 “sales” corresponds to employee 520 “Matthew M”. In some cases, when persona rules are applied (e.g., at 470 of FIG. 4B), transactions that do not satisfy the persona rules for “sales” may be flagged or highlighted (not shown).

In some cases, no additional tagging or highlighting is included and just the persona is shown. In such cases, a user viewing the expense management system GUI 500 can easily visualize that the employee 520 “Matthew M.,” who is associated with transaction 502, has the “sales” persona 530. The visual indicator of the persona may be sufficient to assist the viewer. For example, an approver considering whether to approve transaction 502 may use the information gleaned from the “sales” persona 530 to conclude that it is reasonable for an employee with a “sales” persona 530 to have business expenses including hotel purchases, coffee purchases, and gas station purchases. However, the transaction 506 of a technology store purchase may be highlighted or otherwise stand out due to employee 520 having a “sales” persona 530 if it is expected that only IT makes purchases of electronics.

FIG. 5B illustrates another example receipt tracking view in a graphical user interface of an expense management system. Referring to FIG. 5B, a user (e.g., employee 115 of FIG. 2) may be viewing a receipt tracking view in the graphical user interface (GUI) 540 for an expense management system (e.g., expense management platform 200 of FIG. 2) that displays a summary of transactions corresponding to their company credit card, including transaction 502, transaction 504, transaction 506, and transaction 508. In the illustrated view, the employee can upload their receipts.

In the example illustrated in FIG. 5B, a receipt has not been provided for transaction 508. The user may wish to add the receipt to the expense management system, as prompted by the “attach receipt” icon 545. Because the GUI 540 includes display packages for each transaction, it would be immediately clear to a user viewing GUI 540 that transaction 508, missing the receipt, was a transaction made at Phil's Station with a total of “$9.49.”

Compare transaction 508, displayed at GUI 540 in FIG. 5B, to transaction 148 displayed as part of the GUI 130 of FIG. 1. As can be seen in FIG. 1, given the sometimes cryptic descriptions of merchants found conventionally in transaction information, distinguishing between transactions can require additional effort. The challenges can be further seen where both transaction 144 and transaction 148 have a transaction total 136 of “$9.49”. It will likely require at least some additional time and effort on the user's part to determine what receipt corresponds to transaction 148 and they may be wrong.

Advantageously, providing the transaction display packages for each transaction, as in the case reflected in GUI 540 of FIG. 5B, can make it easier to understand the displayed information and reduce the need to search other sources/utilize additional resources.

FIG. 5C illustrates an example notification message. Referring to FIG. 5C, as described with respect to FIG. 4A, a notification message can be provided by the expense management platform, for example, via a messaging application 550. The transaction display package that includes merchant content such as merchant name 562, a merchant logo 564, and a merchant location 566, along with a transaction total 568 and a prompt or a link to add a receipt 570 can assist with understanding the transaction of interest (and with capturing the receipt back into the expense management platform. As can also be seen, the merchant location 566 provides additional visual indication for a user to know where the transaction occurred.

Embodiments of the described expense management platform and transaction data service may be implemented as a computer process, a computing system, or as an article of manufacture, such as a computer program product or computer-readable medium. Certain methods and processes described herein can be embodied as software, code and/or data, which may be stored on one or more storage media that when executed by one or more processor direct the system to perform the methods and processes described herein. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system/one or more processors) and encoding a computer program of instructions for executing a computer process. It should be understood that as used herein, in no case do the terms “storage media,” “computer-readable storage media” or “computer-readable storage medium” consist of transitory carrier waves or propagating signals. Instead, “storage” media refers to non-transitory media.

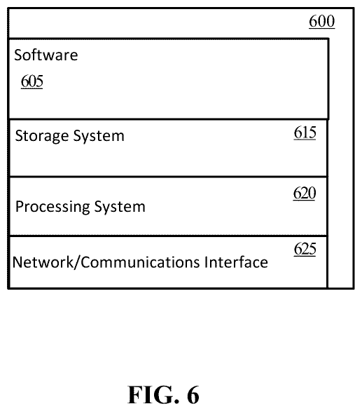

FIG. 6 illustrates components of a computing system. Embodiments of the described expense management platform and transaction data service may be implemented as computing system 600. Referring to FIG. 6, system 600 may be implemented within a single computing device or distributed across multiple computing devices or sub-systems that cooperate in executing program instructions. The system 600 can include one or more blade server devices, standalone server devices, personal computers, routers, hubs, switches, bridges, firewall devices, intrusion detection devices, mainframe computers, network-attached storage devices, and other types of computing devices.

The system 600 can include a processing system 620, which may include one or more processors and/or other circuitry that retrieves and executes software 605 from storage system 615. Processing system 620 may be implemented within a single processing device but may also be distributed across multiple processing devices or sub-systems that cooperate in executing program instructions. Examples of processing system 620 include general purpose central processing units, application specific processors, and logic devices, as well as any other type of processing device, combinations, or variations thereof.

Storage system 615 can include any computer readable storage media readable by processing system 620 and capable of storing software 605 and data. Storage system 615 may be implemented as a single storage device but may also be implemented across multiple storage devices or sub-systems co-located or distributed relative to each other. Storage system 615 may include additional elements, such as a controller, capable of communicating with processing system 620.

Software 605 may be implemented in program instructions and among other functions may, when executed by system 600 in general or processing system 620 in particular, direct the system 600 or processing system 620 to operate as described herein for transaction data service 202 and/or expense management platform 200, for example, with respect to FIGS. 2, 3, 4A, 4B, and 5A-5C. Software 605 may also include additional processes, programs, or components, such as operating system software or other application software. Software 605 may also include firmware or some other form of machine-readable processing instructions executable by processing system 620. In embodiments where the system 600 includes multiple computing devices, the system can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 625 may be included, providing communication connections and devices that allow for communication between system 600 and other computing systems (e.g., including user devices 150A and 150B described with respect to FIGS. 2, 4A, 4B, and 5A-5C over a communication network or collection of networks.

Communication to and from user computing devices, expense management platform, and various services described herein may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving, at a transaction data service for an expense management platform, transaction information of a transaction made with a payment card, the transaction information including a merchant identification;
obtaining, from a merchant data mapping resource, merchant content corresponding to the merchant identification, the merchant content comprising a brand name;
generating, at the transaction data service, a transaction display package comprising the brand name; and
providing, for display via a graphical user interface, the transaction display package.

2. The method of claim 1, wherein generating the transaction display package comprises replacing the merchant identification in the transaction information with the merchant content.

3. The method of claim 1, wherein the merchant content further comprises a merchant logo.

4. The method of claim 1, wherein the merchant content further comprises a merchant location and wherein the transaction display package further comprises a map image of the merchant location.

5. The method of claim 1, wherein the transaction information is received at the transaction data service in response to the expense management platform receiving a call to provide content to display to a particular endpoint where the content to display includes the transaction information.

6. The method of claim 5, wherein generating the transaction display package comprises selecting a particular size or image of the merchant content to customize the transaction display package according to the particular endpoint.

7. The method of claim 1, further comprising:
receiving, at the expense management platform, the transaction information during a pre-authorization process of the transaction; and
generating a notification message, wherein the transaction information is received at the transaction data service during the generating of the notification message.

8. The method of claim 7, wherein providing the transaction display package comprises sending the transaction display package through a communication channel to an employee associated with the payment card.

9. The method of claim 1, further comprising:
applying, by the expense management platform, persona rules to the transaction.

10. The method of claim 9, wherein applying persona rules to the transaction comprises:
identifying an employee associated with the payment card having conducted the transaction;
retrieving persona rules corresponding to a particular persona assigned to the employee;
determining that the transaction does not satisfy the persona rules corresponding to the particular persona; and
applying indicators to cause flags or highlighting to surface in the graphical user interface.

11. The method of claim 1, further comprising:
identifying an employee associated with the payment card having conducted the transaction;
determining an assigned persona of the employee; and
providing an indication of the assigned persona with the transaction display package.

12. A computer-readable storage medium having instructions stored thereon that when executed by a computing system direct the computing system to:
receive, at a transaction data service for an expense management platform, transaction information of a transaction made with a payment card, the transaction information including a merchant identification;
obtain, from a merchant data mapping resource, merchant content corresponding to the merchant identification, the merchant content comprising a brand name;
generate, at the transaction data service, a transaction display package comprising the brand name; and
provide, for display via a graphical user interface, the transaction display package.

13. The computer-readable storage medium of claim 12, wherein the instructions to generate the transaction display package direct the computing system to replace the merchant identification in the transaction information with the merchant content.

14. The computer-readable storage medium of claim 12, wherein the instructions to generate the transaction display package direct the computing system to select a particular size or image of the merchant content to customize the transaction display package according to a particular endpoint.

15. The computer-readable storage medium of claim 12, further comprising instructions to:
apply persona rules to the transaction.

16. The computer-readable storage medium of claim 15, wherein the instructions to apply persona rules to the transaction direct the computing system to:
identify an employee associated with the payment card having conducted the transaction;
retrieve persona rules corresponding to a particular persona assigned to the employee;
determine that the transaction does not satisfy the persona rules corresponding to the particular persona; and
apply indicators to cause flags or highlighting to surface in the graphical user interface.

17. The computer-readable storage medium of claim 12, further comprising instructions to:
identify an employee associated with the payment card having conducted the transaction;
determine an assigned persona of the employee; and
provide an indication of the assigned persona with the transaction display package.

18. A system for an expense management platform, comprising:
a merchant data mapping resource;
a computing system; and
a computer-readable storage medium having instructions stored thereon that when executed by the computing system direct the computing system to:
receive transaction information of a transaction made with a payment card, the transaction information including a merchant identification;
obtain, from the merchant data mapping resource, merchant content corresponding to the merchant identification, the merchant content comprising a brand name;
generate a transaction display package comprising the brand name; and
provide, for display via a graphical user interface, the transaction display package.

19. The system of claim 18, wherein the merchant content further comprises a merchant logo.

20. The system of claim 18, wherein the merchant content further comprises a merchant location and wherein the transaction display package further comprises a map image of the merchant location.
